(19) United States
(12) Patent Application Publication
(10) Pub. No.: US 2021/0128979 A1
(43) Pub. Date: May 6, 2021

(54) SYSTEM AND METHOD FOR MANAGING AND TRACKING ACTIVITY OF A PERSON

(71) Applicants: Steven M. McHugh, Waltham, MA (US); Sean McKirdy, Newington, CT (US)

(72) Inventors: Steven M. McHugh, Waltham, MA (US); Sean McKirdy, Newington, CT (US)

(21) Appl. No.: 17/020,723

(22) Filed: Sep. 14, 2020

Related U.S. Application Data
(60) Provisional application No. 62/899,994, filed on Sep. 13, 2019.

(51) Int. Cl. A63B 24/00; H04B 1/3827; H04Q 9/00; A63B 71/06; A63B 21/072; A63B 21/078; G06K 7/10; G06F 1/16

(52) U.S. Cl. CPC A63B 24/0062; A63B 2225/54; H04Q 9/00; A63B 71/0622; A63B 21/0726; A63B 21/078; G06K 7/10366; G06F 1/163; H04Q 2209/47; A63B 2220/836; A63B 2220/803; A63B 2071/0663; A63B 2071/0666; A63B 2220/40; A63B 2220/17; H04B 1/3827

(57) ABSTRACT

A Wearable Electronic Device (WED) is provided and includes a WED processing device; a WED memory associated with the WED processing device, wherein the memory stores at least one pre-loaded exercise routine; a motion sensor, wherein the motion sensor is in signal communication with the WED processing device, and wherein the motion sensor is configured to sense the movement of the WED and generate motion sensor data: and, communication circuitry, wherein the communication circuitry is in signal communication with the WED processing device and configured to wirelessly communicate with at least one of an exercise device and a RFID tag associated with an exercise device being used by the user of the WED.

### RELATED APPLICATIONS

This application is related to and claims the benefit of the filing date of U.S. Provisional Patent Application Ser. No. 62/899,994 (Atty. Docket No. MCK-0016-P), filed Sep. 13, 2019, additionally this application is related to U.S. Provisional Patent Application Ser. No. 61/764,956 (Atty. Docket No. MCK-0015-P), filed Feb. 14, 2013 and U.S. Non-Provisional patent application Ser. No. 14/181,331 (Atty. Docket No. MCK-0015), filed Feb. 14, 2014, the contents of which are incorporated by reference herein in their entireties.

### BACKGROUND OF THE INVENTION

There are many retail environments that require employees to be responsible for customer onboarding and sales pitches when a prospective or existing customer is interested in a product or service. Even though most companies will create training programs for their employees, it is very difficult to monitor the effectiveness of the onboarding and sales programs in a retail environment. It is also difficult to monitor the individual performance in a time frame that allows a business to make changes to the program to improve performance or even make necessary personnel changes because of lack of compliance to company mandated onboarding and sales processes.

For example, fitness centers have employees that will take potential customers through orientations or sales consultations. The employees are trained either by other staff members or need to read through training documentation/company policies. There is no guarantee that the gym employee will go exactly where their training instructs them to go as part of the sales process, or in the order in which they are supposed to go, or spend the approximate amount of time selling or discussing a particular topic related to a certain area of a gym. Existing methods often prove to be ineffective or require additional management oversight which results in adding more labor expense to the sales process because of inefficiencies and lack of cost effectiveness and scalable monitoring and tracking of employee performance.

### SUMMARY OF THE INVENTION

A Wearable Electronic Device (WED) is provided and includes a WED processing device; a WED memory associated with the WED processing device, wherein the memory stores at least one pre-loaded exercise routine; a motion sensor, wherein the motion sensor is in signal communication with the WED processing device, and wherein the motion sensor is configured to sense the movement of the WED and generate motion sensor data: and, communication circuitry, wherein the communication circuitry is in signal communication with the WED processing device and configured to wirelessly communicate with at least one of an exercise device and a RFID tag associated with an exercise device being used by the user of the WED.

### BRIEF DESCRIPTION OF THE DRAWINGS

The foregoing and other features and advantages of the present invention should be more fully understood from the accompanying detailed description of illustrative embodiments taken in conjunction with the following Figures in which like elements are numbered alike in the several Figures:

FIG. 1 is an operational block diagram showing one embodiment of a method of the invention.

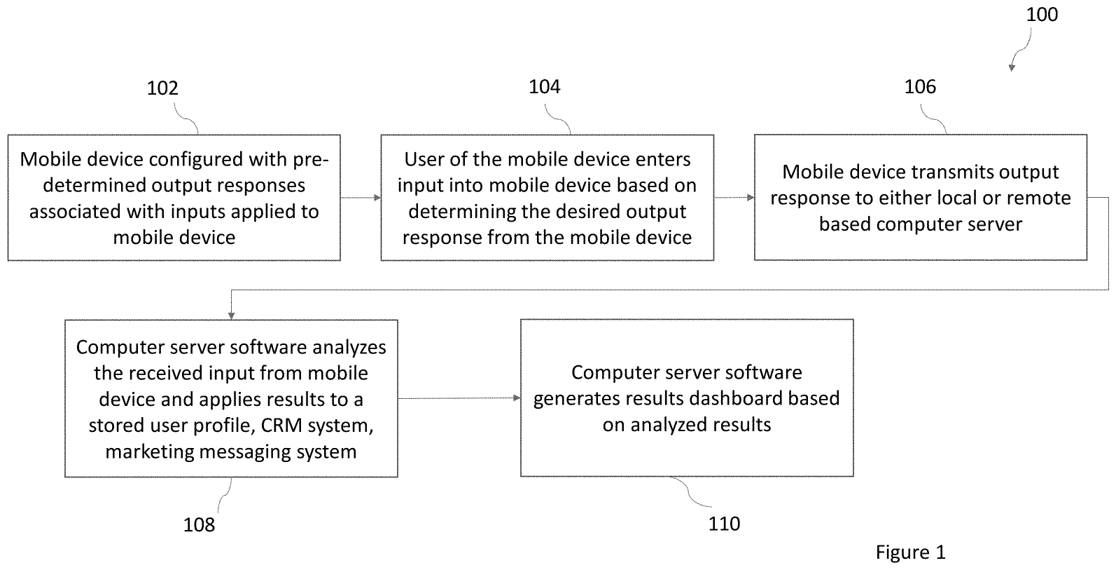

FIG. 2 is a schematic block diagram showing one embodiment of the invention.

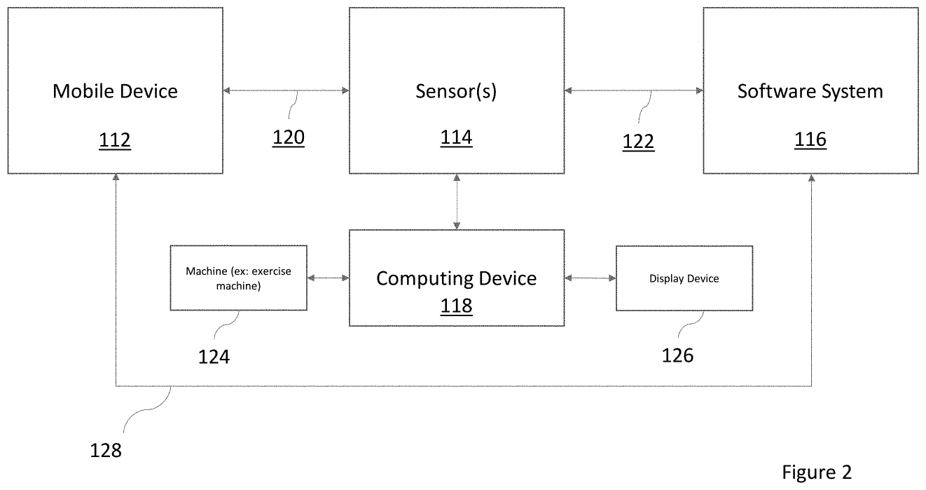

FIG. 3 is a schematic block diagram showing one embodiment of the invention.

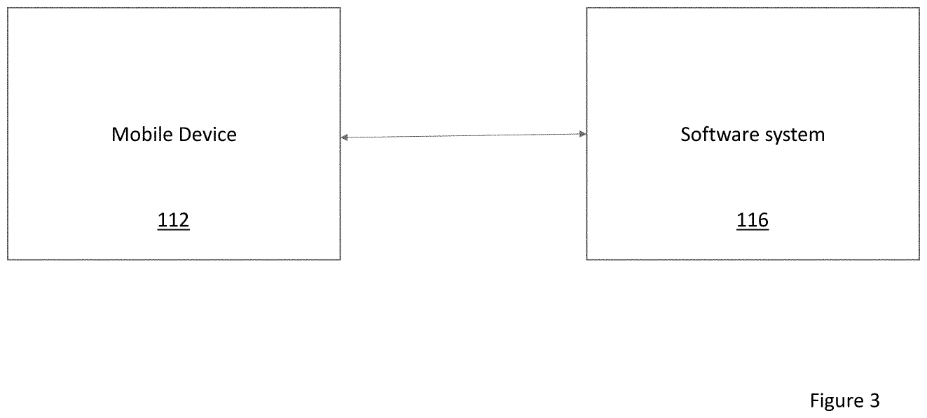

FIG. 4 is a schematic block diagram showing one embodiment of the invention.

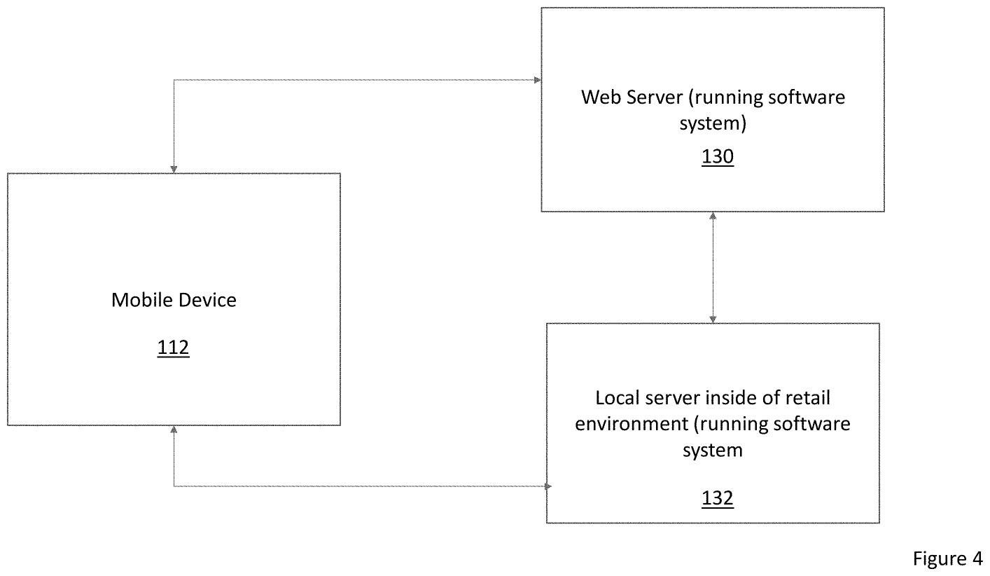

FIG. 5 is a schematic block diagram showing one embodiment of the invention.

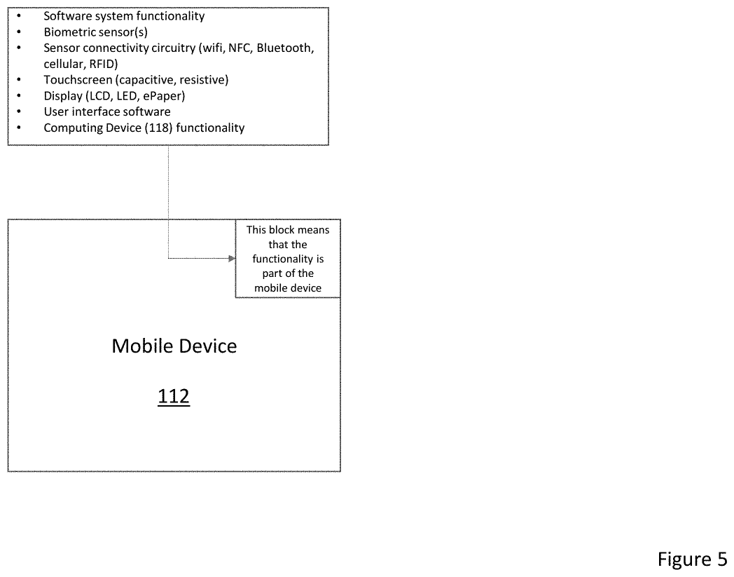

FIG. 6 is an operational block diagram showing one embodiment of a method of the invention.

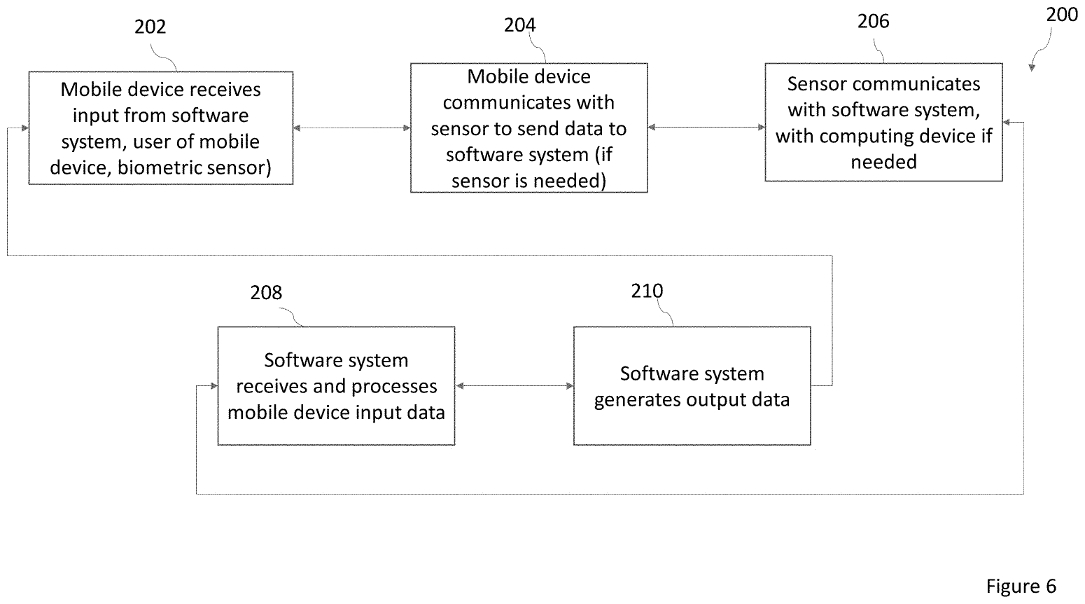

FIG. 7 is an operational block diagram showing one embodiment of a method of the invention.

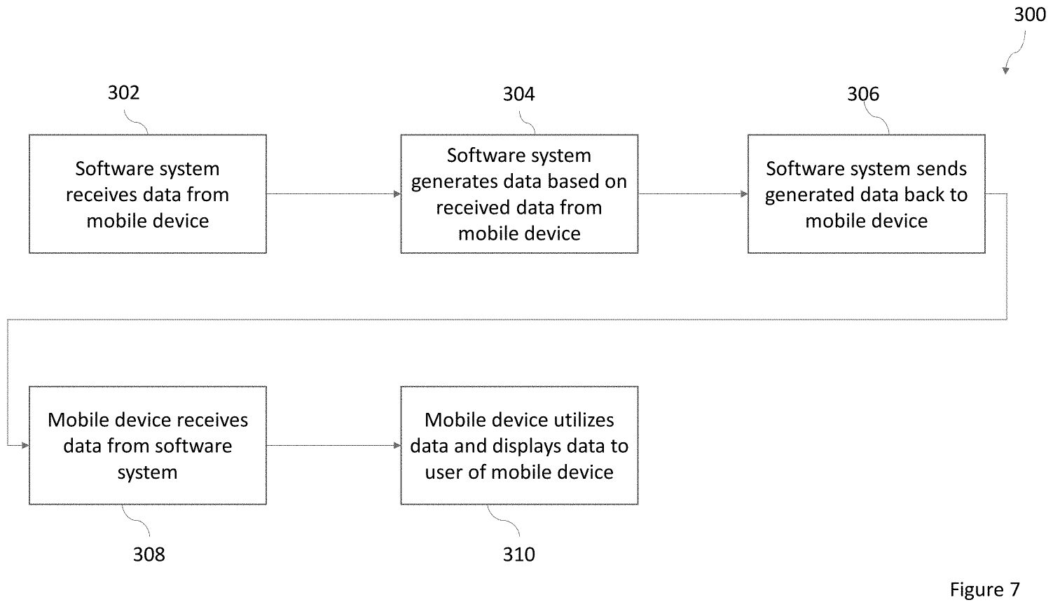

FIG. 8 is an operational block diagram showing one embodiment of a method of the invention.

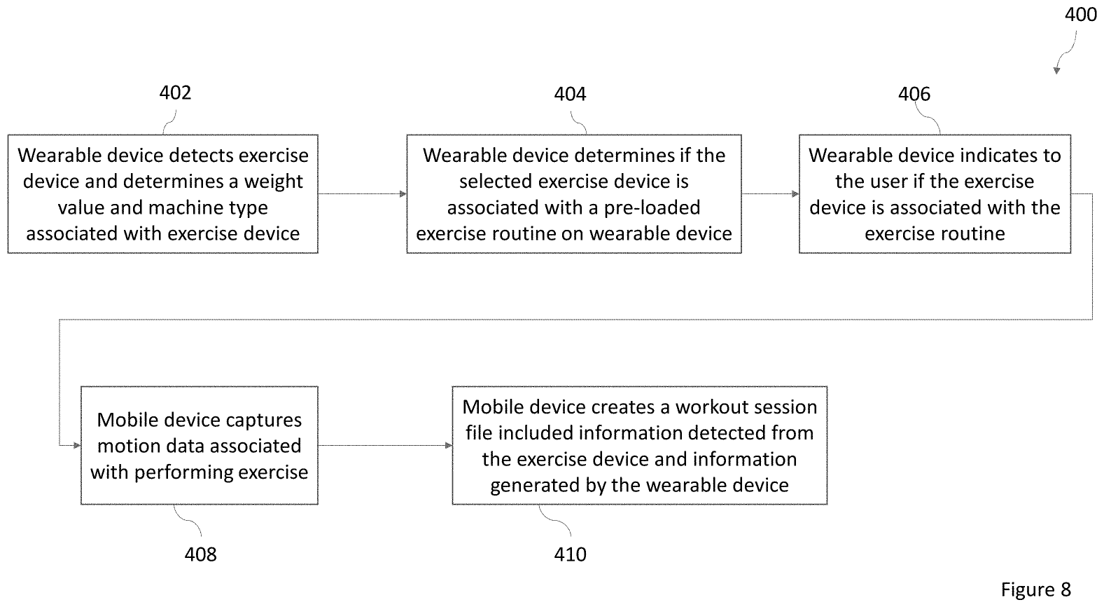

FIG. 9 is a schematic block diagram showing one embodiment of the invention.

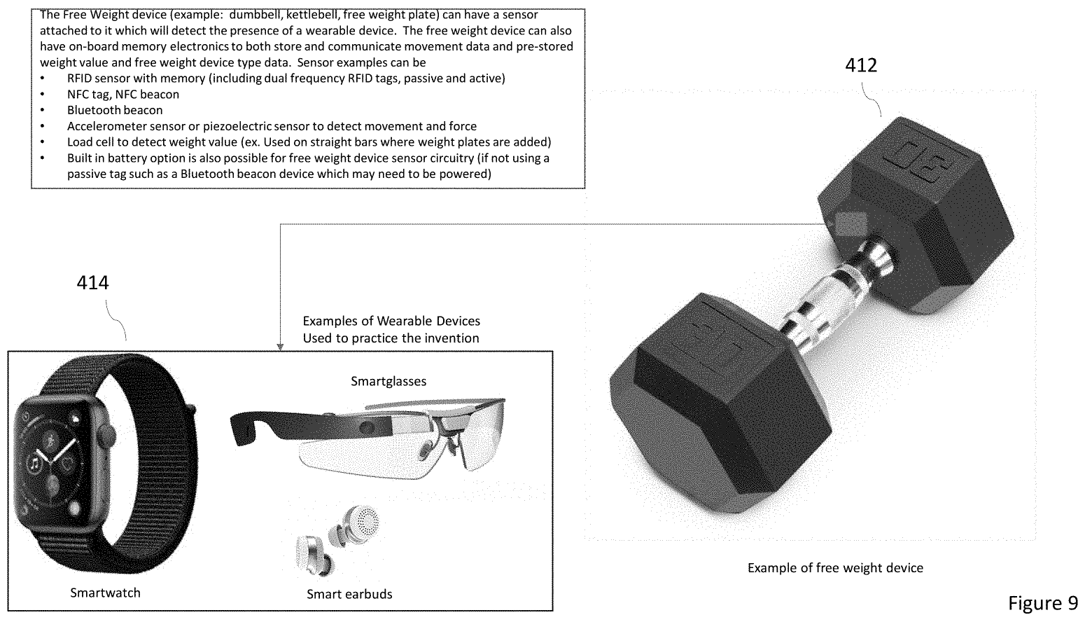

FIG. 10 is a schematic block diagram showing one embodiment of the invention.

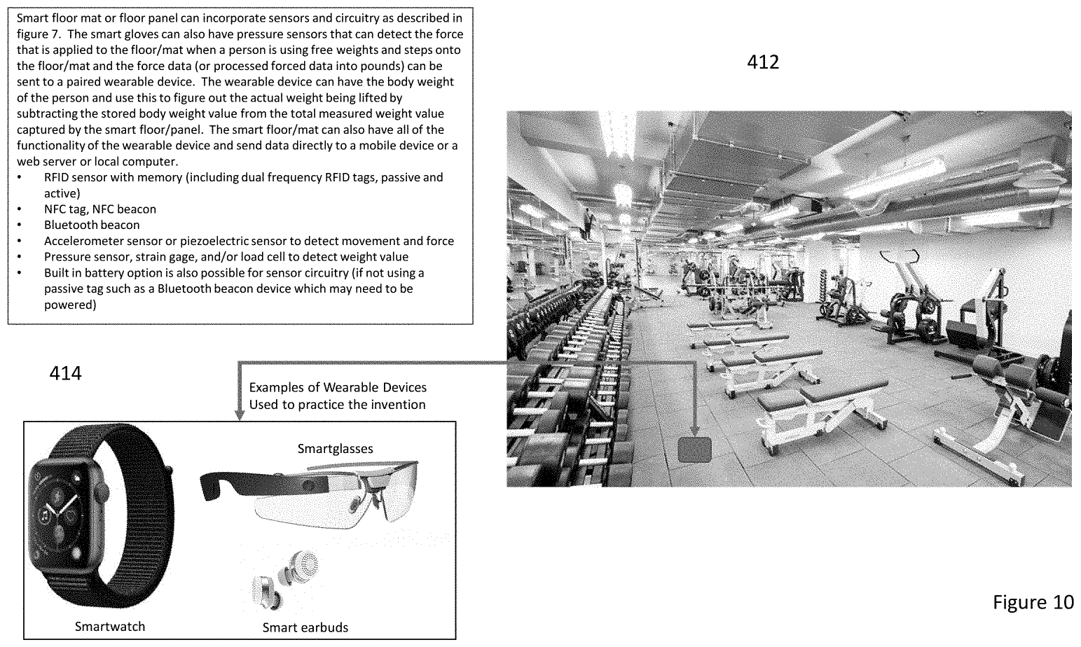

FIG. 11 is a schematic block diagram showing one embodiment of the invention.

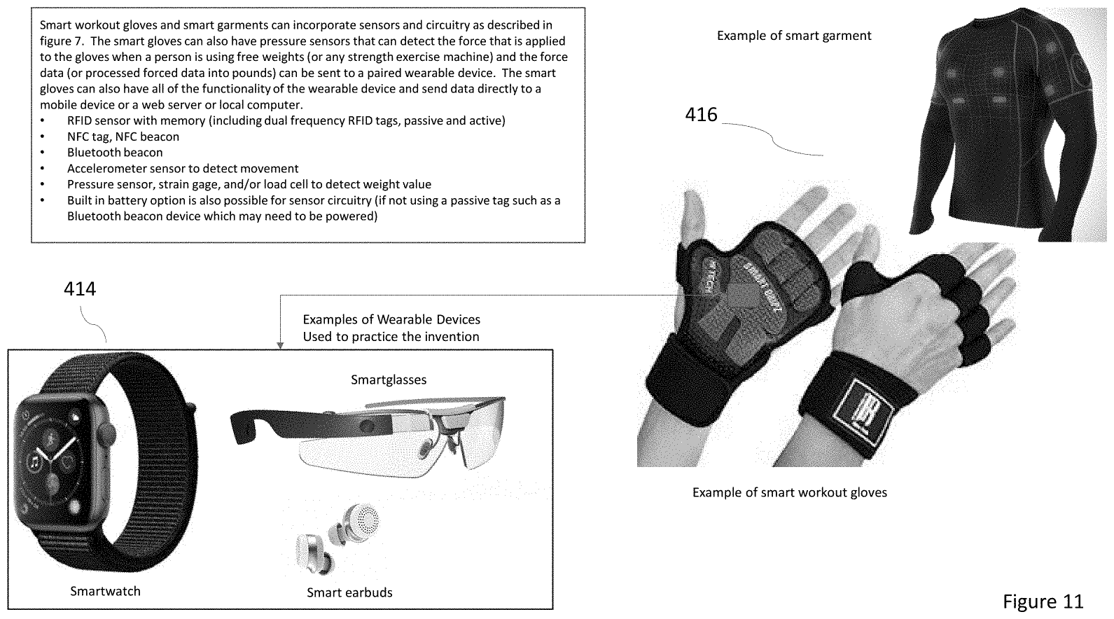

FIG. 12 is a schematic block diagram showing one embodiment of the invention.

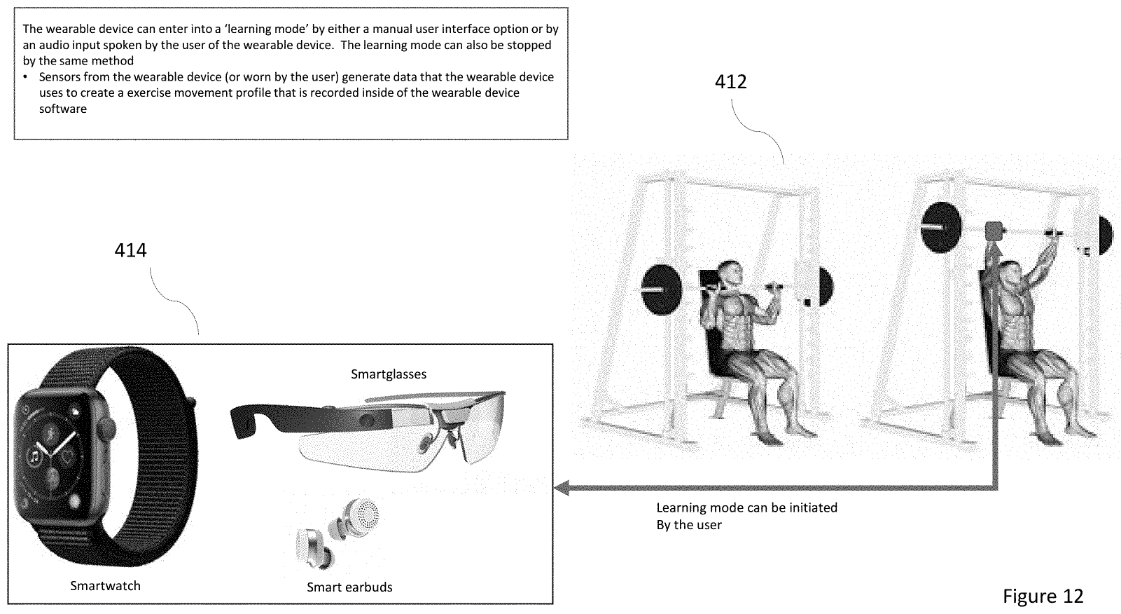

FIG. 13 is an operational block diagram showing one embodiment of a method of the invention.

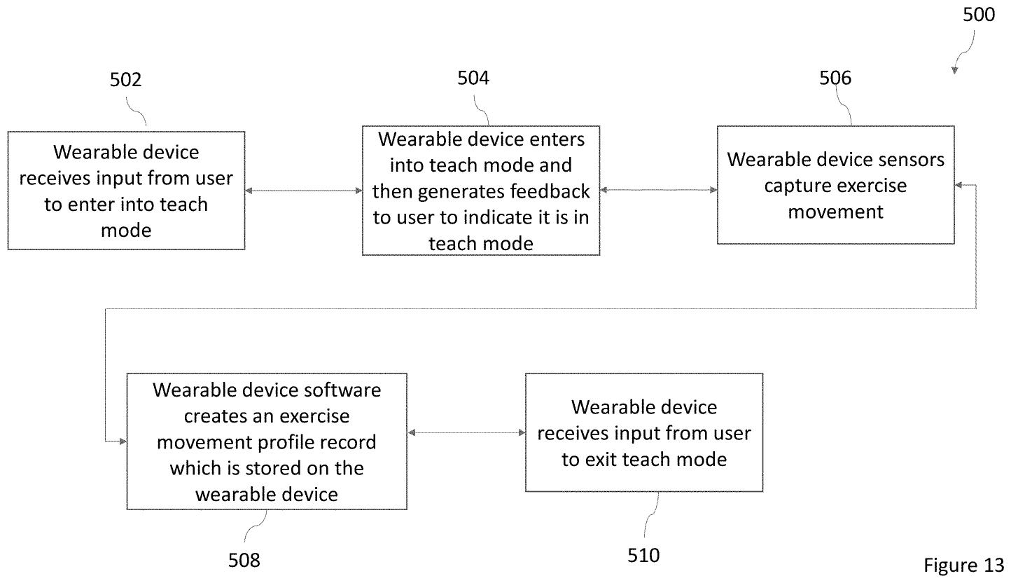

FIG. 14 is a schematic block diagram showing one embodiment of the invention.

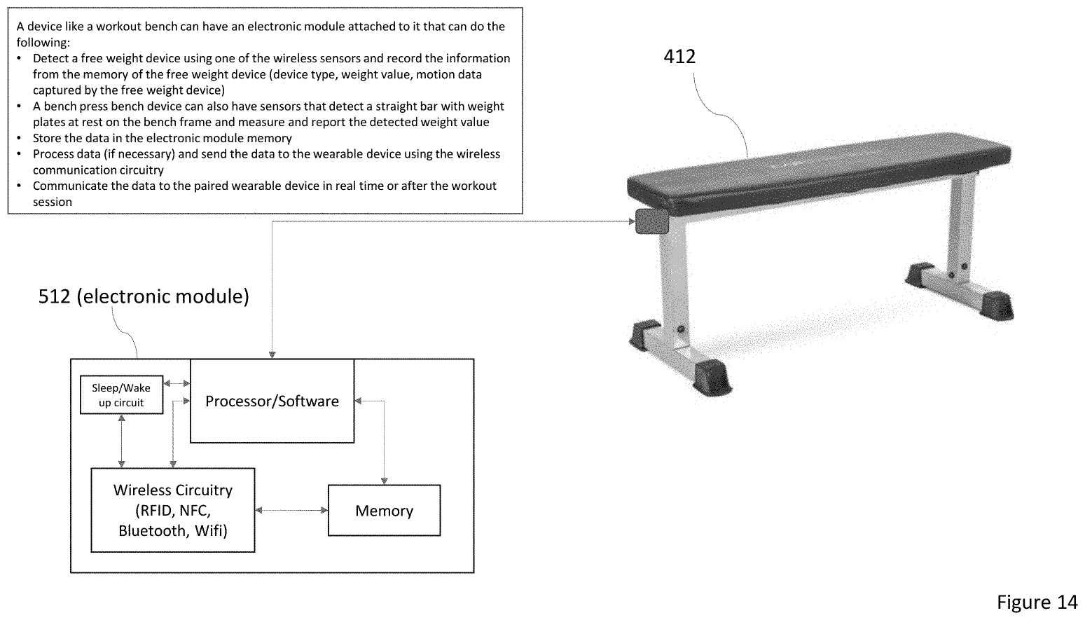

FIG. 15 is a schematic block diagram showing one embodiment of the invention.

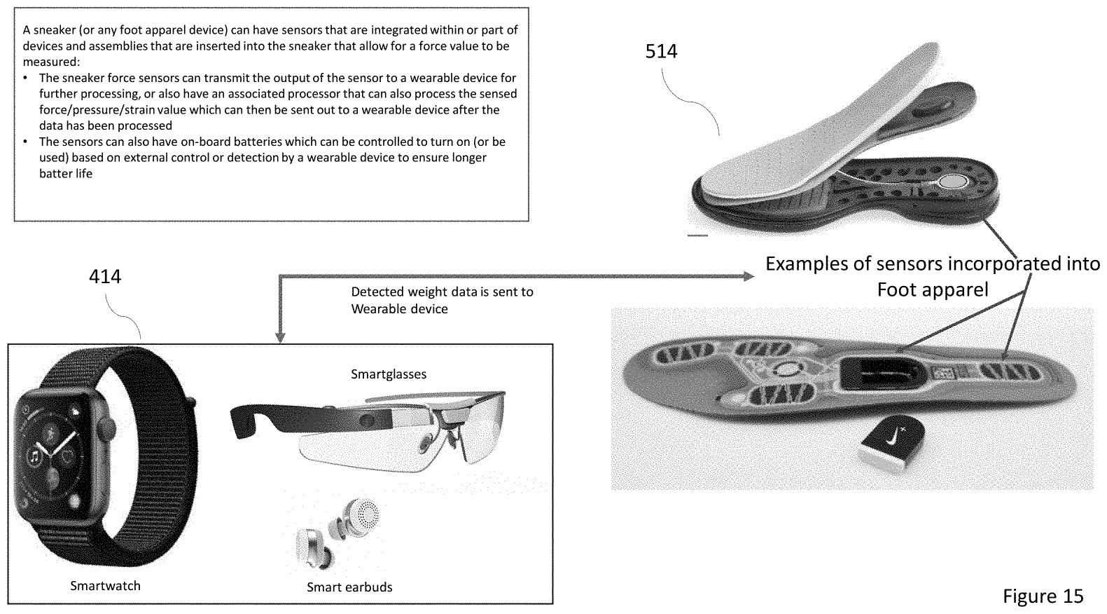

### DETAILED DESCRIPTION

There is a real need for businesses to have options for how they can better manage and deploy their employee resources as well as have inputs from a system that can process captured sales related performance data/feedback and identify opportunities for continuous improvement as well as personnel optimization and/or changes, as well as improve the delivery of marketing content to the prospective customer based on inputs provided by a retail staff person. There is also a real need for wearable devices such as smartwatches to be able to detect the how much weight is lifted by a person exercising using devices such as free weights (dumbbells, kettlebells, etc) without having to manually enter how many sets, reps, and weight lifted was performed into their wearable device or connected mobile device

One aspect of the invention describes the use of sensors and other input types that are networked within a physical building (like a fitness center) where the sensors are used as inputs to start tracking duration of an employee during a sales process or onboarding process. The sensors can be configured on the network to create a zone (or multiple zones), where a zone is part of a predetermined or brand new/ad-hoc sales journey destination. Each zone can be assigned a certain amount of time by the software system that the employee should target spending with a customer (or a range of time like a minimum and maximum) and each zone can be classified with an area or a machine (or physical object) that resides within the physical building space. The employee can use a mobile device to start wireless communications with the sensor (or optical communication or audible communications) and where the mobile device will also be able to have bi-directional communication(s) directly with the software system via a wifi network and/or a cellular network. Once the communications between the employee's mobile device and the zone sensor(s) is initiated, the system software will start a clock that will count the duration associated with zone's target duration time period. The employee will go through their sales process step for that specific zone and then generate an input to the system software (using their mobile device) such as to identify that the sales process step is completed. This will allow the system software to process the duration and generate a score associated with the employees performance against the predetermined time for the sales journey zone, as well as track that the employee actually visited the zone with the customer(s) as they were supposed to.

The employee can also use their mobile device to input feedback during the sales process or onboarding process that the system software can also use as part of an employee score calculation for performance and adherence/compliance to the company's process. For example, the employee might be wearing a smartwatch (or fitness band) like the Apple Watch and would be able to generate an input on the touch screen of the smartwatch at some point during the sales process to indicate how the sales process is proceeding at any particular moment in time. The employee could swipe the screen of the watch up which could indicate that the customer was expressing interest in what was being discussed during that portion of the sales pitch or swipe the smartwatch screen down to indicate that the customer was not interested (these are just example as multiple directions can be assigned to a swipe screen gesture by the system software where the inputs can be used by the system to determine different inputs that are predefined by the system administrators, but not limited to ‘swipe gestures’ as user interface buttons and icons on a mobile device can also be used for inputs by the employee).

The sensors can be associated with (example: physically attached to) or even integrated with (example: part of the machine or device) machines and fixtures (such as exercise equipment, light fixtures, electronic displays on the wall or attached to equipment or computers, audio speakers) so the sensors are easily accessible to the employee's mobile device. For example, exercise machine's can be made to include the sensors as standard features so their customers can benefit from smarter machines that will have the capability to help reduce labor costs associated with selling memberships. In this instance, the sensor could be integrated fully into a cardio machine (either in the frame, as part of at least one electrical circuit board that reside within the exercise machine or a display associated with an exercise machine) or the sensor could be a device that is affixed to the outside (or on the inside of a plastic shroud) of the exercise machine such as a sticker or label, or a wireless electronic beacon device such as a Bluetooth beacon or Wifi beacon. The sensor may also be part of an electronic device that gets its power from a communication port provided by the exercise machine (such as a CSAFE electronic module). In this scenario, the electronic device may also have a processor and software that communicates with the exercise machine when a mobile device interacts with a sensor associated with the exercise machine (used as a trigger or switch) which could be used by the system software to generate a command to control the display of the cardio machine or display screen device attached to an exercise machine (such as a demo video of how to use features of the machine or how to use the machine, display images related to using the machine, show tutorial videos on how to use a function of the machine or a service that is offered by the facility) where the system software could send a command to the exercise machine that is in a zone so that a targeted message is displayed to the employee and the customer during the portion of the discussion during the journey.

The system will use at least one wireless network to perform and/or enable the communication between the employee's (or customer's) mobile device, the sensors in the zones of the retail environment, a local computer or remote computer server (referred to herein as ‘computer system’ (if needed because the mobile device can also perform all of the functions of the local and/or remote computer server) and any equipment or other devices identified by the system administrators as being associated with any sensors. The communication between the sensors and the computing system can be facilitated by a computing device that contains circuitry and communication protocols that will enable the computing device to establish bidirectional communication (if two way communication is needed) with the sensors located in the facility as well as the computer system software. Communication protocols such as the ‘Eddystone Protocol’ can also be used as required to support functionality of the mobile device and sensors of the invention as needed (https://en.wikipedia.org/wiki/Eddvstone (Google)) and (https://developers.google.com/beacons/eddystone).

For example the computing device can contain a Bluetooth hardware module and software that allows the computing device to communicate with Bluetooth beacons that are located throughout the facility. The computing device could also contain Ultra High Frequency (UHF) RFID module and software that allows the computing device to communicate with the UHF sensor tags and/or labels, and/or sensors that are located throughout a retail facility environment. The computing device can also contain a Wifi module and software that allows for the computing device to communicate with the computer system. It should be appreciated that the computing device can be at least partially or fully integrated into the computer system, or also be its very own separate device that is in signal communication with the computer system. The computing device may also be integrated into equipment such as exercise machines or electronic devices attached to exercise machines such as display screens and CSAFE data communication modules. This would allow the exercise machines to have more intelligence as a standard feature set where the software of the exercise machine could be configured to support the functionality of the system for the facility based on software menu settings that are part of the exercise machine software set up. For example, information regarding the facility name can be entered into the exercise machine software menu or even a unique location ID value so the computer system would be able to receive data from the computing device (or exercise machine, or CSAFE module, or display screen) so the computer system can associate data that is sent by the computing device (or any mobile device that is generating input that is in communication with the computer device) with a specific facility. The same information can also be encoded in the software of the computing device.

The sensors within a defined retail environment zone (such as Bluetooth beacon sensors) can also be configured so they can be used to automatically detect an employee's mobile device based on a detection range associated with the Bluetooth beacon sensor device. This could help automate the starting of a zone's timer (managed by system software) for the sales discussion by having the employee walk over the area and the system could provide a form of feedback to the employee that they are in the right zone and/or that the timer for that zone has started. The feedback could be the form of a message displayed to the employee on their mobile device, a haptic feedback delivered by the mobile device to user (such as a vibration), and audible sound, a color change of a display screen on the mobile device, a display screen change on the mobile device, the appearance of icons/buttons on the mobile device when in the active zone, greyed out buttons or interface options on the mobile device now become enabled and usable when the employees mobile device is in the sensor zone (this would be helpful since if the employee is not following the sales script (or sales journey) these feedback options may not happen such as the buttons not appearing or that the greyed out buttons or user interface options on the mobile device continue to stay greyed out and unusable because the employee is not in the correct zone).

The system software would be able to receive the data inputs generated by the employee's (or even customer's) mobile device and the computing device and process the received data to generate various outputs. For example, if a sales journey has a total of five zones destinations associated with a retail environment and the employee only visits three zones during the sale process with a new customer, the system software will receive the data inputs from the three zones that are visited by the employee and creates a score value for at least one of the zones and also the total sales journey. The system software may also take into account the amount of time that the employee stayed within each zone, and also take into account that the employee did not visit two of the five zones and then generate a score that is lower based on the two missing data points for the two zones not visited during the sales journey. Data inputs that can be generated by the employee's mobile device can also be used by the system software for generating an output (refer to above for example the mobile device input of swiping a smartwatch screen up to indicate interest by a customer in a specific zone as an example for input type example). The system software can also generate notifications, reports, and update software dashboards to the management of the retail environment and owners of the retail environment which shows data regarding employee compliance to the business's established employee sales and customer onboarding processes.

Additional outputs that can be generated by the system software are reports that show performance over time of employees such as compliance to sales process steps, as well as indictors and recommendations for opportunities to sales process improvements if a non-compliant employee (based on low score values) is not spending as much time as the sales process demands but yet the employee is linked to a high conversion rate of sales and membership sign ups (the system software may have a fully built in customer/lead management system capability that tracks customer conversions, or the system software can also be in communication with an operational system that the facility uses as well as a separate CRM system where the required data to track and link customer conversion data resides).

The amount of time that a mobile device is used by the employee when the employee is in the proximity of a sensor zone (including a ‘geofence sensor zone) will generate data that can be used by the system software to identify the interest level of the customer or lack of interest (if the system is tracking time that exceeds the maximum threshold value associated with a sensor zone, the system software may be able to determine that there was a higher interest level or perhaps a need for follow up marketing materials to be sent to the customer because of this extended time period. Bluetooth beacon sensors could be one example of how the system could detect the continued presence of a mobile device in a zone that could generate this type of input. This will create a standardized approach for a business so they can measure staff performance and improve marketing communications to customers using machine learning an automated marketing tool sets such as platforms like Hubspot that can deliver targeted based content marketing. In this scenario, instead of filling out a form on a website which typically generates a content marketing campaign experience, the input that is generated during a customer visit to a retail location can be used to determine the type of content and the frequency of content that is sent to the customer (or prospective customer).

For example, if a person is on a tour of a fitness facility and they are not sure if they want to switch from their existing gym to go to the new gym they are exploring and learning about during a sales consultation, the system could detect that they were interested in one area of the facility more than another and make recommendations to the system administrators or other facility staff members to market specific content to that person every week. The system could automate this by taking the data inputs that are generated by the sales staffs mobile device (i.e. swiping gesture inputs) and then use marketing content for the services or products that the customer expressed interest in to create an automated marketing campaign (or drip marketing campaign) based on these types of inputs. This would remove the administrative labor associated with datamining through CRM system notes that are entered by employees as well as eliminate marketing labor efforts used in creating content marketing campaigns. The retail environment sales staff employee could make inputs into their mobile such as facts that the customer uses a smartphone or wears a smartwatch where these inputs could also be used by the system to target the type and the format of the marketing content that could be sent so as to ensure the highest chance of consumption by the customer or prospective customer (other inputs made by the system user could be that the customer has active social media accounts so the system would started sending messages and posts specific identified relevant content the customer had expressed interest in that was captured by the employee on their mobile device during the sales process steps). The system could also send marketing content to the person via SMS or MMS text messages or even through platforms like Snapchat or other messaging systems (the customers or prospective customers contact information would be retrievable from either the CRM system database, the business operational system database for the facility, or the system would be able to search the internet for the contact info and collect the information from publicly available sources and input that information into the database record for the customer.

Geofence sensors can be associated with electronic devices that are part of exercise equipment, electronic devices attached to exercise equipment, wifi networks, Rfid sensor tags such as UHF, LHF and NFC sensor tags with embedded memory and antennas, nfc hardware or labels, mobile devices, associated with lighting fixtures, associated with flooring materials, QR code labels and display devices, Augmented Reality codes/images, or other barcode technologies that are printed, silkscreened, painted, digitally displayed. Bluetooth sensors such as beacon technology, wireless mesh networks using Zigbee enabled devices, electronic displays associated with exercise equipment that have any of the above mentioned sensor or barcode or wireless capabilities, audible sensor solutions such as chirping can also be used as inputs into the mobile device because the mobile device can detect the audio output using built in sensors of the mobile device.

The sensors can be configured to create zones by the system software. Each sensor zone can have a minimum and maximum time threshold for how long a staff member dwells in a zone, this data can be analyzed and applied to a scoring system for each zone (low score for less time, high score for max time, low score or penalty on score because too much time is spent in the zone and its costing too much labor dollars during a walk through).

For low cost implementations, a RFID tag can be used as a sensor network solution. A UHF tag can receive signals from a RFID module (computing device) that is connected to a network (example: a local area network (computer system) inside the facility or a remote network). The UHF portion of the tag can be used to program the sensor tag or label because it has range capabilities for wireless communication with the RFID module. The same sensor tag or label can have a NFC (near field communication) communication capability which can be used to communicate with the staff (or customer's) mobile device. The memory portion of the sensor tag could be shared or accessed between both the near field communication portion and the longer wireless range portion (UHF portion for example). When the staff mobile device comes in contact with the NFC portion and energizes the RFID tag/NFC tag, the tag responds with information that is associated with the zone the tag has been assigned to it by the system software (such as a unique ID code for the rfid tag or asset ID for a machine, floor level, building column identification value, exercise machine serial number). Once this trigger happens, a clock starts to count on the system software for how much time the staff is dwelling in the zone, the clock can stop once the user initiates an end point in the software application (or web application) running on the mobile device. The system may prevent the staff member from entering or starting a new zone in the sales process until the clock has been stopped. The software system clock/timer may stop also if the staff member brings the mobile device in close enough range to communicate with the RFID/NFC tag a second time since the sensor tag is networked as described above, once the sensor tag is first initiated by a mobile device, the system can send information from a remote computer that can be stored in the RFID writeable portion of the memory (for example: last detection of a mobile device, staff ID of the mobile device user, start timer command, end timer command). This information can be a code or command type that can be detected by the mobile device to stop the clock from counting for that specific zone visit.

The mobile device can also be in communication with the network to allow messaging and controls to take place on the mobile device. For example, if a mobile device initiates communication with a FRID tag (or other sensor type such as a Bluetooth sensor or a wifi network), then a staff member should be engaged in executing the sales portion of the sales script associated with that zone in the facility and when the maximum time threshold for that zone is exceeded the system can initiate a message or other visual indicator to be displayed on the mobile device so the staff member is aware that they should try to finish the discussion for that area of the facility if they can. If the staff person is finished at any time during their sales pitch they can enter an input into their mobile device (press a button, swipe the screen, multi finger touch on a touchscreen, use fingerprint sensor associated with the mobile device, speak into the mobile device shake or move the mobile device so the built-in MEMS accelerometer sensor circuitry can be used as an input) so the system will stop the clock from counting and then can be ready to move onto the next zone that is part of the journey. If the mobile device does not receive any of the above described inputs, the system may not allow the staff member to view the next display screen or content piece that is part of the prescribed sales journey. After a certain amount of time (predetermined by the system software) the system will stop the sales journey reporting because the system software will know that there is no activity going on, this will help to filter out data from the system that could result in incorrect post data processing and reporting.

The functionality of part or even all of the system software and communication modules and capabilities can be run on software applications that reside on a mobile device (or more than one mobile device that are in communication with each other such as a smartwatch device or a head worn display device such as ‘smart glasses’ with a display screen in wireless communication with a smartphone).

The system can be automated to allow for a customer to use their own mobile device to explore or take a new customer journey through a facility without the need of a staff member, removing the labor costs associated with the employee. The mobile device of the customer may have prompts displayed to the customer and interactive media and content such as floor plan layout maps specific to the facility they are physically part of the facility. The mobile device may be running a software application that is on the mobile device or may perform the functions using a web browser application (using HTML 5 for example where a mobile device using HTML 5 or greater can have control over wireless communications and sensors of the mobile device).

The system can also be used for existing customer retention purposes. For example, if a person who is a member of a fitness center has a mobile device with a software application that is associated with the fitness center or is provided access by the gym to a fitness center application, the member's mobile device would be able to benefit from being able to provide input into the system such as the location the member is in throughout their visit to the gym (this can also work with other retail environments listed). The member's mobile device software application would be able to have the capability to automatically enable the required wireless connectivity capabilities of the mobile device as described that would allow the member to communicate with sensors in a location zone or even exercise equipment or displays and electronic module attached to exercise equipment (this function could also help with automatic connectivity with exercise equipment for exercise machine control and workout tracking by not having the member have to think about turning on their Bluetooth settings on their mobile device). The system would be able to monitor and track data of the member such as location related data and zone dwell time or duration data of the member and use this data to improve the relationship with the member. For example, the system would be able to know the type of equipment and services the member has or has not shown an interest in and the system would also be able to communicate with a member management system which stores information about the member such as scheduled sessions at the facility and payment history. The system would be able be able to use this information to send targeted marketing and promotional information to the member in order to better market based on the likes and dislikes of the member where that information is derived from tracking and monitoring the member while they are in the facility through the member mobile device. The system would also be able to have a content scheduling and communication capability that would allow advertising and promotional content be sent to a person using an exercise machine which has a display screen. The exercise machine would be in communication with the software system and would be able to receive content (video, audio, images) where the content can be stored inside memory associated with an exercise machine display or a display screen attached to the exercise machine.

The content can be triggered for display based on the system software receiving an indication that a member is on a particular machine and/or identified as being inside of a sensor zone where the exercise machine is known (by the system software) to be located. The content can also be determined based on inputs from more than one member and their mobile devices that are being (or has been) identified as being inside of a sensor zone where the content scheduling capabilities of the software system (or even content scheduling capabilities of an exercise machine or display attached to an exercise machine or external content management systems in communication with exercise equipment hardware) can cycle through various content for display priority. The content can be related to products and services that are offered by the facility or sponsored advertisements for 3^{rd} parties that are paying to advertise to a targeted demographic inside of the retail location. The content management system can also be separate from the software system (but still be in communication using an API software interface that connects both systems to facilitate content scheduling information and content sharing and delivery). The system can also use the tracked data from detecting the presence of a mobile device in a sensor zone to automate marketing content delivery to the member that can be delivered to the member using augmented reality technology where the content is displayed to the member via their mobile device display (sent from a web server for display on the mobile device display) based on when the system software detects they are actively in a sensor zone or have visited a sensor zone within a pre-defined time frame or amount of time. For example, a person could be approach a treadmill in a fitness facility and their mobile device would detect a sensor which would cause the system software to send relevant marketing content and/or messaging to be displayed to the user which could be delivered via augmented reality technology such as being overlaid or displayed on a display screen of their mobile device such as a ‘smart glass’ device.

The system can also be in bi-directional communication with social media network systems and other contact databases (such as Jigsaw.com or data.com) and have the ability to automatically or be set up to manually allow the software system to follow or subscribe to social media accounts of a customer or prospective customer (such as Facebook, LinkedIn, Instagram, Snapchat) where the system can have filter capabilities in the software that will eliminate and sort out any duplicate names that are on a social network system and limit the names based on information it detects such as the name is in a geographical area that would make sense for that person to be interested in the products or services sold by the retail location, listed interest of the person on the social network, posts that reference the retail location or competitors of the retail location, education history of the person, relationship status of the person, a connected person in their social media network who is either an employee, vendor, or a customer of the retail location. The system can use information it retrieves from the social networks to update the at risk retention status of a customer if it sees information posted on the social network that could be determined to mean the member may stop purchasing products or services from the retail location such as a change in address, a health status change, a relationship change, a post that shows the customer is showing interest in competitor products and services, check-in status updates by the customer on the social network that could indicate a lifestyle habit that indicates a habit that goes against the products/services of the retail location (such as unhealthy habits or competitive options the customer is taking part in), geographic check-ins that indicate time being spent in other places when the customer used to spend that time in the retail location, the content of a post where the mood of the customer is negative and could indicate that member will not as actively visiting the retail location (the mood can be detected by machine learning software programs that learn from previous posts and then can look for words and conversations of a customer that would indicate a change in mood), engagement levels and activity type (such as posts, likes, comments, sharing activity) of the customer on the social media network comparing and analyzing the frequency of social media activity of the customer such as posting pictures and posts compared to historical social media activity of the customer (using machine learning if needed).

The system can take these inputs from a social network system or other database systems and modify the retention risk status of a customer on the system (or on a business software operation system that is in communication with the system) where the system can visually indicate the status of at risk customers to the staff of the retail location using reports and software interfaces for the system software so the staff of the retail location can have immediate access to this information to be proactive about trying to get the customer back into a positive standing with the retail location. The inputs that can be generated by communicating with a social network system or database system can also be used by the system to automate targeted marketing content to the customer as described in this document. The system can also be configured to find geographically relevant potential customers that are related to a customer or prospective customer using the same interaction with social media networks as described in this document. This would allow for the system to generate new leads and customers for the retail location based on its existing and evolving customer base and would allow the retail location to maximize its marketing efforts. The geographic relevance of the potential customers can be pre-defined in the system software and would benefit from the software filtering and sorting methods described.

The scores that the software system generates for each sensor zone can be weighted based on the profit center for a facility. For example, a gym has high profit centers for training areas so more time should be spent explaining the services. Under minimum duration time in that zone could mean that the employee did not take enough time to explain and sell the higher dollar value service which could hurt the financial position of the business and result in a lowered score for the employee for that zone session or the overall sales journey session.

The time thresholds for each zone can be linked to scripted or predetermined and approved sales pitch strategies that the facility wants to have their staff follow exactly. If the minimum and maximum threshold is not being met at each zone, that could be an indicator that the employee is deviating from the sales process script.

The system can monitor the scores and the sales conversions of customers linked directly to staff members, if a staff member is getting low scores, but has higher customer conversions for sales, the system can identify this staff member as a possible source for process improvement to help reduce the labor associated with customer sales efforts while also improving conversions. The system may also apply machine learning algorithms using score data and sequence of zone visits as inputs to help optimize the sales pitch journey inside a facility for new members. The path of the journey can be displayed to the staff member using a connected mobile device such as a smartphone, laptop computer, smartwatch like the Apple watch, tablet device, or wearable display devices with speakers for audio and other sensory inputs (such as vibration sensor) such as Google Glass, or any ‘smart glass’ device.

The retail environment can be a fitness center, a clothing and apparel store, a grocery store, a jewelry store, a car dealership, a boat dealership, a manufacturing facility, a billiards store, a video game store, an electronics store, a tabacco or cigar store, a coffee shop, a gas station, a hotel, a resort, a museum, a hospital, a hotel, a health food and supplement store, a education facility, a tradeshow booth, a bowling alley, a fast food restaurant, a hardware store.

There are additional applications and environments and/or situations that can benefit from what is described in this invention. For example, the use of a mobile device (such as a wearable device like an Apple Watch or Samsung Galaxy Gear watch) could be used as a way to easily allow a person watching a sporting event (either in their home, at a sports bar, or even in a live event such as a stadium or arena) to provide input in real time to plays, calls made by officials, commercials/advertisements, entertainment (such as cheerleaders or performers). For example, a person could be sitting in their living room watching (or listening via radio or other audio system) a football game and if their team has a bad or questionable call made against them by the referee, the person would provide input to a cloud based software system using their mobile device using the methods described above (such as swiping gestures, speech inputs, user interface buttons) where the inputs may be pre-defined. For further example, a person wearing a Apple Watch could swipe the touchscreen of the watch down if they did not like a call that was made. The software of the system (residing on the mobile and/or in a remote web server) could receive this input and generate feedback to the user and/or generate a visual representation back to the user(s) of the system such as a score based on other users' feedback on the same play call where the feedback can be displayed on the mobile device of the user(s) or even on a TV display where the event is being watched.

This would allow for an unprecedented viewer interaction with the event they are watching. If the user were to provide input on their mobile device multiple times in one direction (i.e. multiple repeated swipe gestures in the ‘up direction’ on a Apple Watch) the software system could detect these multiple inputs to mean the user is putting extra emphasis on their feeling about the play that was called. This could also be used as part of a rating score that could be processed and generated (for display) by the software system where multiple scores could be generated as a viewable summary report after the event so viewing participants as well as advertisers (and even game players/teams) can review and analyze the data and derive value from the data. Viewers would be able to see how others viewed reacted to the same event based on their mobile device inputs which can be used drive discussion boards. The advertisers would be able to get actual demographic data (gender, location, event viewing time information, etc) about viewers which makes the data and system extremely valuable to parties that make money selling advertising such as TV stations, pay per view channels, radio stations, etc. . . . because the system would be able to have the ability to target advertisements specific to a segment of viewers that could be displayed back to the viewers' mobile device during the event making the delivery of content personalized. The advertising content could also be generalized based on normal advertisement programming. The system would be able to synchronize timing and time zones of the viewers and the event to ensure alignment of feedback and system functionality so when the viewer interacts with their mobile device the input is assigned to an action of an event (such as a play call) or a displayed advertisement the viewer either hears or views on a screen (the screen can be a TV, a tablet, or a big display screen inside an arena where the viewer is watching the event).

The mobile device would be able to offer the viewer an event selection option that would allow them to pick which event (sporting event for example) they want to have their mobile device linked to. The mobile device software application (or even the remote system software) can also auto select the event based on pre-defined preferences that are linked to the user of the mobile device. For example, an Apple Watch may have stored user (viewer) information in the device memory (or be connected to a remote server where the user info is stored), or may even be able to detect the user based on biometric inputs from sensors associated with the mobile device that detect such things as pulse rate, blood pressure, skin color, movement patterns associated with the user (recognized movement patterns). The user information can be used by the system to automatically select the type of event programming such as date, time, channel that the viewer will participate in so they do not have to manually select their option. This system can also allow a person to benefit from a discounted event rate if they are subscribed to the system. The content provider (for example, the Ultimate Fighting Championship company) would stand to make even more money from the event based on people who could be watching the event at a sportsbar but did not necessarily directly pay for the event. Mobile device inputs may require more than one input of the same type (ex. Same direction like a swipe gesture) before the system will accept the input. This can be used to as part of authenticating a real input instead of a view accidentally making a single input command into the mobile device. For example, if a viewer is watching a sporting event on their TV like a boxing fight and inadvertently touches their phone, the system could take that as an input so if the system (or mobile device software) was set up to require more than one input of the same time within a certain amount of time that would help will telling the system that the input is real and not an accident.

Another application the mobile device feedback capability could be applied to is restaurant settings. Staff in a restaurant could use a mobile device (like a smartwatch) to indicate there is a slippery floor immediately. A waiter wearing a smartwatch would have their smartwatch in communication with sensors (sensor types mentioned earlier) that could be attached to tables so a software system is able to detect where the waiter is located in the restaurant based on proximity of their mobile device to the sensor nodes. The sensor nodes are in communication with a wireless network also as described above. The input types for the mobile device can be configured by the restaurant specific to meet their needs such as pre-defined input types such as customer feedback on their meals and their wait staff service, staff input notifications, emergency communications to the rest of the staff such as someone is having a medical emergency in a specific sensor zone or that someone is choking. Customers in the restaurant would also be able to participate in this system as well to provide input to the retail location staff such as service feedback and quality of food product feedback.

Another application would be a security setting such as an airport security line or a shopping mall. Security personnel would be able to easily indicate potential issues without raising awareness to people around them or potential suspects by using the above described input methods using mobile devices.

Another application would be a manufacturing environment where employees work at a factory can utilize mobile devices to quickly indicate that there is a problem or question related to a component or manufacturing process. For example, if a machine breaks down a person can use their mobile device to indicate immediate feedback into a system that monitors machine up-time which can trigger maintenance personnel to know exactly which machine is not working. If a manufacturing process is being reported as taking longer than it should, the system could be used to monitor the efficiency of the employee that is working in that area of manufacturing that has the inefficiency and could detect how many actual minutes is a person in the physical work zone which could be defined by sensors (as similar to the described retail environment application). If an employee is not physical located in the sensor zone by their mobile device, the system would be able to track the amount of time they are not physically there in a work shift and provide updated reports to their supervisor or human resource department. The system can utilize biometric sensors associated with the mobile device such as an accelerometer, a heart rate sensor, a blood pressure sensor to authenticate that the person is actually wearing or has physical possession of their mobile device and has not left their mobile device in the manufacturing zone and left to go take a break. The sensor zones can also reside outside of the manufacturing facility such as assigned break areas so the system can accurately track how many minutes the employees are taking on their breaks and when the break time is over or nearing completion the system can indicate to the employee on their mobile device that it is time to return back to their work area.

The system can detect when the employee returns back to their work area which will provide a full accounting of physical locations of an employee during a work shift. The employees can also use the system to indicate when there is a quality alert related to a manufacturing process or inspection process. This would allow a manufacturing system such as MRP (manufacturing resource planning) and ERP systems (enterprise resource planning) to record these employee generated inputs which can be used to append quality records associated with the manufacturing of products (such as medical devices, consumer electronics, aerospace hardware and systems, medical diagnostic equipment). The MRP and/or ERP (manufacturing system) can use this information to generate outputs to other groups that support the manufacturing and quality inspection of products or even send information to the supply chain entities that provide products and services associated with a manufacturing and/or assembly of the product. For example, if a aerospace manufacturing company that sells aircraft engines had this system, their employees would be able to provide quality indications (good or bad) to their supply chain when a problem is suspected or confirmed which would streamline the flow of information. For further example, an engine fan blade could have a coating that is needed to protect the component in the hot section of the engine and if a incoming inspection quality inspector working at the aircraft company were to identify a defect with the coating such as a color issue or a area that was not coated but was supposed to be the quality inspector could use their mobile device to indicate the type of the quality defect into the system and the coating vendor would receive notification (email, text message, fax) from their customer (the engine manufacturer) where the coating vendor would use the information to verify any issues with their manufacturing process (personnel changes, equipment breakdowns, etc).

If the coating vendor had this same monitoring and tracking system for their own manufacturing process, the two manufacturing systems would be able to exchange information efficiently to help identify possible root causes to the manufacturing defect. In this example, the quality inspector's mobile device would be able detect the type of product using a sensor (such as a camera with image recognition software or wireless sensor like RFID or NFC) which could be used to ensure that the mobile device user interface options where specific to the product they were inspection. The user interface options of the mobile device could have pre-defined quality alert options as well as instructions on the inspection methods that should be used to inspect the product. The user interface options on the mobile device could also have menu selection capabilities that would allow the user to select a quality alert report function in the event that the inspector were to find any defects. The user interface options could also display historically quality related information for the product type that is accessible from the manufacturing system of the company the employee works for or even for a vendor that provides a product or service used in the manufacturing of the product the employee is inspecting. The manufacturing system would be able to generate trending data and reports based on the employee generated inputs from their mobile devices which could be used to better manage the manufacturing business.

Another application would be a retail environment such as a grocery store or electronics store. The invention would allow a customer to let the staff know they are looking for assistance without having to be embarrassed by walking up to a staff member during uncomfortable situations where the staff member is already talking to a customer in the store. The system would be able to prioritize the staff member resources based on when a customer submitted an input using their mobile device into the system. This would allow the system to monitor the efficiency and the performance of their staff as they respond to these customer generated inputs. The system would be able to monitor and record the amount of time a customer spent in a sensor zone in a retail environment using the detected mobile device associated with a user and could use this information as inputs to drive targeted marketing information that can be sent to the customer's mobile device (such as current specials, coupons, promotions, new product offerings, services, reward program registration information).

The system could also provide updates to the customer on their mobile device such as when a staff member will become available so the customer could not have to stand around wondering when a staff person will provide service to them. The system could also receive and utilize (process) the customer generated inputs where the customer generated inputs to the mobile device are as described in this invention document and which may further include information residing either on the mobile device, at least partially generated by the mobile device such as pulse rate, body temperature, stress levels using sensors associated with the mobile device, information that may be stored on the mobile device or on a network and/or remote server that the mobile device is in or can be in communication with such as name information, gender, age, health information. This information can be used by the system to customize the type of information that is displayed to a customer on their mobile device or even on an electronic display that is identified on the system as being able to be seen or is designated for a specific sensor zone in the retail environment. In the example of a display that has received targeted information from the software system based on at least one customer input from a mobile device (either customer generated or customer mobile device generated), the display may also have sensors such as camera sensors and other optical and audio based sensors and other hardware (time of flight sensor, Infrared sensor and associated IR blasters and transmitters. RBG sensor, color camera sensor, at least one microphone, depth camera, infra red projector). The system can use these sensors and hardware in combination with facial detection software, gender detection software, age detection software, face emotion detection software, audible input detection software to further monitor a customer that the system software has identified as being in a specific sensor zone. Using inputs from at least one of the various sensors associated with the electronic display, the display software can send additional information back to the system software that can be used by the system to further customize a customer experience.

For example, once a customer has been identified by the system as being in a sensor zone, the system may initiate a communication with an electronic display device to start monitoring the customer using at least one of its sensor types. When the electronic display device is able to detect the customer and capture an input using one of its sensor (such as a facial emotion), the software system may utilize this information to generate and output based on the information that is being received from the display device. For example, an angry facial expression of the customer can be detected by the display device and the system can react based on this input by sending a coupon to the customer's mobile device (or email address or home address via mail) which is designed to retain the customer with the intent to improve or change the angry facial expression that was detected. The system software would be able to monitor any change or action the user takes by receiving the coupon (or discount) such as a future redeeming of the coupon by the customer. The system software can also use a dwell time of the customer in sensor zones as an input for sending a customer a coupon or promotional message and/or item.

The system software would have pre-defined duration values for how long a customer should stay in a zone and if they are dwelling for longer than the threshold time range or limit, the system can initiate sending the coupon/discount/marketing material/promotional content to the customer. The system can also use the collected data from either electronic display device and/or the customer mobile device to generate output information that can be shared with a marketing system which is responsible for content delivery to existing and prospective customers. The system can become more intelligent about how its customers/prospective customers are engaging with their brand based on the inputs captured by the display device and/or the sensor device. For example, the system would be able to monitor the physical path of its customer's through a retail environment and capture information related to their customer's experience such as customer demographic information, the amount of time their customers spent inside of sensor zones which can be linked to product/services for sale, facial emotions of the customer, biometric data of their customer where this data can be used by the system to deliver a more customized experience that can change based on the population segments (male/female, age, ethnicity) of customers inside of the retail environment at any time. This would allow the system to fully optimize and to continuously learn from real data inputs that are generated by sensors located within the retail environment and/or sensors associated with the mobile devices of their customers.

The mobile device can run an embedded software application(s) in order to deliver the functionality of the system described, including machine learning software. The mobile device can also run a web browser that has permissions and access to mobile device sensors, hardware, software functions (such as HTML 5 capabilities). In the example of a web browser implementation, the system software could be accessed by the mobile device via wireless network (wifi, cellular. GPS, etc) where the user interface options (user generated inputs on the mobile device) are able to be customized remotely without having to worry about updating the software of the mobile device (such as a smartwatch). The web browser software running on the mobile device may also have access to circuitry (and associated software) residing on the mobile device such as near field communication (NFC) circuitry, Bluetooth circuitry, wifi circuitry, cellular circuitry, touch pad circuitry, touch screen circuitry, body metric sensor circuitry, GPS circuitry . . . where the web browser software is able to use the embedded hardware circuitry to perform the functions of the described embodiments in this invention. For example, the web browser software would be able to utilize the Bluetooth circuitry or NFC circuitry to establish a communications link with a RFID sensor tag that could be located in a fitness center as described in this invention document and could allow the mobile device to operate in similar fashion with the RFID sensor tag as if the mobile device was running an embedded software application (such as those downloaded and installed from the cloud based Apple Store or the Google Store).

The mobile device can have the ability to teach or configure the backend system of the system so the system can have sensors linked to specific equipment and/or locations inside of a retail environment. For example, the mobile device can communicate with a sensor in order to configure it (such as writing a unique ID code to the sensor memory if desired) and identify a sensor as being associated with a location or machine inside of the retail environment. The mobile device software can wirelessly communicate with a sensor (or use hardwired methods if needed) and capture at least one unique identifier value or code from the sensor and then present the user with a screen with a user interface that will allow the user to enter a location value for the sensor on the backend of the software system. This will allow the system software to know where data is coming from in the retail environment. The mobile device is connected to the software system using a wifi or cellular communication link. This will allow for quick and efficient system configuration especially with NFC enabled RFID sensors that do not require any built in power supply source.

The mobile device can have the capability to use its embedded circuitry and sensors to automatically control when its wireless communication abilities are enabled that can communicate with a sensor. For example, the mobile device can have a GPS capability that would be used by the software on the mobile device to detect a distance to a retail environment and when the mobile device comes within a pre-defined distance range of the retail environment (managed by the system software or the mobile device software) the mobile device may enable and turn on or turn off communication settings automatically. Settings such as wifi communications, Bluetooth communications, RFID communications, NFC communications can be some of the functionality that is turned on automatically based on a proximity to a location or known address that is stored within the mobile device or available to the mobile device using a searching function like Google search. The mobile device can also use a wifi communication capability to turn on other wireless communication capabilities such as Bluetooth and NFC circuitry. This functionality would have the mobile device software looking for wireless networks that can be scanned by the mobile device for retail environment identification data such as the name of a store. For example, a retail store such as Walmart would have at least one wireless network having a name such as ‘Walmart1234_5G’ and when the mobile device software detects and authenticates at least a portion of a wireless network name such as Walmart in this example, the mobile device software enables/activates the appropriate wireless communication method that is supported by the retail environment which has the detected and authenticated wireless network.

When the mobile device is no longer in range of the detected and authenticated wireless network, the mobile device software can be configured to automatically disable the wireless communication capabilities it had previously turned on. This would help improve the user experience of the system since not everybody has their Bluetooth function turned on all of the time on their mobile devices and this would allow customers to not have to worry about remembering to enable the appropriate wireless communication capabilities. This could also be applied to MAC address ID values and advertisement data field packet information such as advertisement data field may include information of GATT (Generic Attribute Profile) service UUID(s), manufacturer information, transmit power, RSSI etc., that are detected by a mobile device where the information from a data field packet that can be detected by the mobile device (for example, from a Bluetooth beacon sensor) could also have some detectable values that the mobile device software would identify, analyze/process, and authenticate in order to provide a similar functionality as listed above. The mobile device does not necessarily have to be connected to the wireless network or to a sensor in order to benefit from the above functionality, although being connected would also still support the same functionality.

The system can also use multiple wireless networks within a retail location to create pre-defined sensor zone(s) as described in this document where at least one of the name of a wireless network and the associated signal strength of the mobile device on that wireless network (as measured by the mobile device software) can be used by the system to detect an approximate location of a customer in a retail environment. The mobile device would be able to send the signal strength values (on a continuous or periodic basis) to the software system which could be correlated against a signal value threshold level that is pre-defined in the system software or that same correlation analysis and processing could occur on the mobile device and the mobile device could inform the system software by itself what sensor zone the mobile device is located in.

The software system (such as software running on a remote web server) may send a message like a text message, SMS message, MMS message, custom system specific message similar to an Apple iMessage to the mobile device which may include a web browser link. The web browser link could direct the user to open a web browser page on the mobile device that would display messaging and user interface options that would allow the user to engage with the mobile device to deliver the functions described in this invention document. The software residing on the mobile device may also use location tracking such as wifi and GPS coordinates as inputs (or other inputs such as RFID sensor tag detection or Bluetooth sensor device detection) to automatically display a user interface to the user which would provide a seamless way to prompt the user to user their mobile device and to interact with it. The sensors described in this invention can also be integrated into or plugged into a USB port associated with tablet devices that are mounted on a wall or other mobile devices, computers. MP3 players, radios, Televisions, cable set top boxes, computing devices using speech recognition (such as the Amazon Echo and Alexa service) with voice command and speaker capabilities, coffee makers, refrigerators, microwaves, video game consoles, vehicles.

Another aspect of the invention includes using a wearable device (for example, a smartwatch like the Apple Watch or other mobile devices like a smartphone) to detect information about an exercise session when the person using the wearable device is using free weights. For example, a free weight device such as dumbbell can have sensors (and associated circuitry such as a processor and a wireless transceiver) attached to the free weight device. The sensor can detect when a person's wearable device comes near the sensor attached to the free weight device using wireless protocols such as NFC. RFID, and Bluetooth. If the sensor is a RFID passive tag, the wearable device can activate the RFID passive tag and retrieve data from the memory that is associated with the RFID passive tag sensor electronics such as the weight value associated with the free weight device. The wearable device can then use this received data as an input and also use the motion that the wearable device captures from its very own sensors (accelerometer, MEMS sensor, heart rate sensor, sweat sensor) and create a workout session profile record on the wearable device which includes the weight value lifted by user as detected from the free weight device as well as the sets and repetition data that can be generated by the wearable device using the motion sensor data to calculate the sets and repetition data.

The free weight device sensor circuitry may also be able to track and record the motion (including processing motion data to derive number of sets and repetitions) when the free weight device is used and can transfer this data to the wearable device when in communication with the wearable device. The wearable device software can also have a timer capability which can be used to add new data to a workout session profile record when a free weight device is detected by the wearable device. For example, if a person wearing an Apple Watch first picks up a 20 lb dumbbell set and performs a set of 10 repetitions, the wearable device will create a record that 20 lbs was lifted 10 times on a first set. If the user were to put down the 20 lb dumbbells and rest for 1 minute and then pick up a 30 lb dumbbell and exercise, the wearable device would add on to the workout session profile that the user has performed another exercise now using the 30 lb weight while also calculating the sets and repetitions. The timer on the wearable device could be configured by the user (or by a user's trainer) so that after a certain amount of time that would pass when there was no movement by the wearable device associated with using a free weight device or by detecting a free weight device, the wearable device software would create a new workout profile record so the new weight value and sets and repetition data would not be incorrectly added to a previous workout profile record. The wearable device can also offer the user a user interface option to manually start a new workout profile record to capture a fresh set of exercise data.

The wearable device can be configured to automatically pair (communicate and receive information from the free weight device) with the free weight device when it comes into proximity with the free weight device. The wearable device can also provide a user interface to the person wearing the wearable device to allow the user to manually select the a specific (pre-loaded) free weight device identifier that is stored within the software of the wearable device. The free weight device sensory circuitry can also have free weight device type data stored within its own memory which can be transferred to the wearable device which will allow the wearable device software to display more detailed information to the user about the type of free weight device they are using. This information can also be used by the wearable device to compare the input data received from the free weight device against a pre-stored workout routine that resides on the wearable device (or a paired mobile device) so if the pre-loaded workout instruction is to have the person use a specific free weight device such as a 20 lb dumbbell and the user instead picks up a 30 lb dumbbell, the wearable device software may display a message to the user not to use the heavier weight device or may generate an audio command to that can be heard by the user of the wearable device.

The wearable device may also change the display of the wearable device to signify that the user is not following a pre-determined workout routine based on the received input from the free weight device, such as changing the display of the wearable device to show a color indicative of not following the workout program (example: the wearable device display may turn red until the user starts using the correct weight value associated with the pre-determined workout routine). The wearable device may also use other built in sensors such as vibrations sensors which can be used to indicate to the user that the person has not selected the correct weight device. The correct weight device value may also be set to as a range of weight values within the wearable device software but can also be linked to a very specific single weight value for a specific set and repetition.

Wearable devices may also include other items that are worn by the user such as smart garments (shirts, shorts, etc.) and also ‘smart workout gloves’. Smart workout gloves with sensors embedded into them such as sensors that can detect and measure force, pressure, and/or strain (example: load cell, piezoelectric sensors, accelerometers, strain gage). Smart gloves also having at least one processor and communication circuitry to sense data from a person using a free weight device, generate data from the sensed data, and communicate the sensed data and the generated data to another device that is in communication with the wearable device such as a smartphone or tablet device. An example of a smart garment would be a shirt that is worn by a user where the shirt has embedded sensors such as accelerometer or strain gages that can both detect motion and force and also embedded communication circuitry that would detect the type of free weight device the person is using.

The smart garment (another type of wearable device) would be able to have all of the functionality described herein. The smart glove/garment may also be able to indicate if the user has selected the correct free weight device associated with a prescribed workout routine by similar methods described herein (example: LED lights that are part of the smart glove/garment that will show a color associated with the correct/incorrect weight device detected, generate a vibration to the user, generate audio commands based on the received input from the free weight device). If a person was wearing two smart workout gloves, their wearable device would be configured to receive data from both smart workout gloves and could determine what type of exercise the user was performing based on the same type of motion or alternating motion of the wearable smart glove devices. For example, if a person is wearing a pair of smart gloves had 20 lb dumbbells in each hand, they might alternate the movement of each hand to isolate each bicep and the wearable device would detect the motion of one hand at time and determine that 20 lbs was being lifted (through the embedded weight detection sensors inside of the smart gloves measuring the weight value). If a person were using a straight bar and holding onto the straight bar with both hands while wearing smart workout gloves, the wearable device would detect the motion of both smart gloves moving at the same time and would receive data from either one or both smart gloves which could be representative of the amount of weight the person was lifting based on the measured weight value from the smart glove(s) embedded sensors. The smart gloves could also be in direct communication with each other where one glove could be the ‘master’ and the other could be a ‘slave’, where the master smart glove device would be receiving measured weight data and movement data from the slave glove device and process and send the measured weight data (and movement data) to the wearable device for further processing and analysis.

The smart glove design can also benefit from having its own power supply (battery) which could be managed and turned on/off based on the movement detected by the smart glove or by being in communication with a wearable device or mobile device. A wearable sensor device like a smart glove (or smart garment like a shirt, a belt, a pair of shorts, a pair of sneakers with embedded sensors for weight detection and measurement) can have flexible circuitry/electronics used to accommodate the design of a workout glove allowing for the electronics to conform to the contours and shape/size requirements of the smart workout glove.

Devices such as exercise sneakers (or work shoes or protective foot apparel) can also have sensors that are integrated with the sneakers that allows for the detection of measured weights that a person is holding onto. For example, a sneaker (or a pair of sneakers) can have at least one sensor that is configured to measure the force applied to the sneaker. The sneaker can also have communication circuitry that would further allow the sneaker sensor(s) to communicate with external devices such as a wearable device and a mobile device. If a person wearing sneakers with integrated weight measuring sensor(s) picks up a free weight device, the person's wearable device would be able to detect the change in the amount of weight based on the added weight value that is detected by the wearable device when the person is standing still. The wearable device can have software capabilities to query the sensor based on a motion threshold being met (example: little movement detected meaning the person is standing still) and would use this time to get the detected total measured data or sensed force value (or already processed weight value) from the sneaker sensor. The output of the sneaker sensor value can be a multitude of electronic output signals related to the type of sensor technology being used, such as a change in resistance value of a strain gauge sensor, a change in impedance value in a strain gauge sensor, a millivolt or milliampere value based on sensed force value from a piezoelectric sensor, strain gauge, pressure transducer, or load cell. The wearable device can receive this input from the sneaker sensor, calculate the total measured force value and convert that value into pounds (or other weight units of measure), and then subtract the user's known body weight which is stored in the wearable device to derive the weight of the free weight device they have picked up. The ‘smart sneaker’ can have multiple sensors working together that can be used to detect a full range of detect weight allowing the sneaker sensor configuration module to generate an accurate force measurement. The smart sneaker can also have a single force sensor solution that can also be used to detect the full force value. The wearable device can provide messaging and other indicators to the user (audio and visual messaging) that indicate that the weight value of the free weight device has been calculated and received and that the user may proceed with their exercise routine.

Other devices such as floor panels, exercise benches/seats, and exercise mats (i.e. items that a person may sit on our stand on while exercising) can also have sensors and circuitry that would be able to detect the total weight of a person when they are using a free weight device (example: chest press bar with weights, dumbbells, kettlebells) and generate a total weight value which can be sent to a wearable worn by the user who is exercising. When a person approaches an area that is supported by a device such as a floor panel that can detect and measure weight and the information associated with a free weight device such as the weight value and type of free weight device, the smart floor panel (or carpet) can process this received information and communicate it to the wearable device of the person exercising. The wearable device can provide a user interface that allows the user to manually select which floor panel/weight bench/mat/etc they are workout out on. The wearable device can also automatically pair wirelessly to the floor panel/weight bench/mat/etc they are workout out on. The floor panel/weight bench/mat/etc may also transmit information that is stored inside of its own circuitry such as a location ID associated with where the device is located inside of a physical building such as a gym. This location ID information can be used by the wearable device software for how to guide a person correctly for a workout routine to ensure that they are using the correct exercise equipment as prescribed by a pre-loaded workout routine residing on the wearable device.

A weight bench can also have sensor electronics (such as a flat bench used for chest press exercises) where a straight bar has free weight plates on either side of the weight lifting bar and when the loaded weight lifting bar is resting with weight plates on the bench the sensor electronics are able to detect the amount of weight the user is going to be bench pressing (or other exercise types). The sensor electronics can include a load cell or a strain gauge which can detect and process the weight amount and then in turn prepare the captured weight data to be sent to the person's wearable device for tracking. The sensor electronics can also capture a full workout session and store the data in memory associated with the sensor electronics attached to the weight bench and then allow the person to have the data sent to their wearable device after the workout session (sets and repetitions) are completed on the weight bench station.

An electronic module can also be attached to devices such as workout benches and seats that can detect a free weight device with wireless circuitry that is part of the electronic module. The electronic module has on-board power supply (battery) and also a sleep/wake up circuit that can make the battery life of the electronic module efficient. When the electronic module detects a free weight device coming into proximity, the electronic module wakes up and begins working. When the module has not detected a free weight device for a certain amount of time, the module will go into sleep mode to conserve battery life. The module can receive all of the data that can be generated by the free weight device and then process the data to make it ready to be communicated to the wearable device or mobile device of the user. The module can communicate the data in real time to the wearable device during a workout regime, or store the collected data from free weight devices and then communicate the data to the wearable device after a workout session is completed if the wearable device has not connected itself wirelessly to the electronic module.

The module has memory, a processor, and wireless communication circuitry such as RFID. NFC, Bluetooth, and WiFi to perform the necessary communication functions described. The user can connect their wearable device automatically by using connection methods by bringing their wearable device close to the electronic module so the wireless circuitry of the electronic module can detect the wearable device (example: NFC proximity of Apple Watch like how Apple Pay or Apple GymKit works). The user can also manually select which electronic device they want to communicate with and control the start and stop of communications through a user interface provided by their wearable device. The electronic module can be presented by naming conventions stored within user's wearable device such as ‘workout bench #1’, ‘incline bench #2’. The electronic module can also be associated with an area of a fitness center such as a floor space area and not be attached to a bench or seat unit. The electronic module software can have location ID information stored inside of its software and this location ID information can also be updated by an external device (such as a smartphone or wearable device) to encode the electronic module with a new location ID value in the event the electronic module location needs to be changed.

The wearable device can also have pre-existing movement patterns that are associated and linked to a specific exercise movement and type. For example, a wearable device can provide a user interface which allows the user to put the wearable device into ‘teach’ or ‘learning’ mode. Once the wearable device has been put into teaching mode, the wearable device software will start to record the movement data that is generated from the built in multi-axis accelerometer (or external motion sensors that are worn by the user in communication with the wearable device) when the person is performing the desired movement path associated with a specific exercise type (example: bicep curls or tricep push downs) and it will create an exercise movement profile record. This exercise movement profile record will be stored within the wearable device memory and can be used by the wearable device software to automatically identified the type of exercise the person is performing in the future and will add any sets, repetitions, and weight value that is also detected to the recorded workout session record. The teaching capability can also be initiated by the person using an audible input command which can help make the recorded movement start and stop function easier to perform during a workout routine.

For example, if a person is sitting on a weight bench seat and is going to perform a shoulder press exercise using a Smith machine, the user will have both their hands holding a straight bar so the user would be able to speak either into the wearable device or earbuds in communication with the wearable device, the user would say a start command to initiate the teaching mode such as “Teach Mode” which would be recognized by the wearable device software. The wearable device software may then provide some type of haptic feedback response to their user such as a vibration response felt by the user or even generate an audio response such as a countdown that the user hears so they can get ready to teach the wearable device with the exercise movement. When the teaching is completed, the user may then again command the wearable device to stop recording movements in teach mode by saying an audio command such as ‘Stop teach mode”. The user could also manually initiate the wearable to exit the teach mode by a user interface on the wearable device using buttons and touch screen swipe gestures. The wearable device can also receive pre-programmed movement paths from remote devices such as a web server or a smartphone or tablet which can be stored in the wearable device software. This would allow the user to benefit from new exercise movements that could be generated by a subject matter expert such as a certified trainer.

The wearable device may also contain sensors that can automatically detect the weight value of a free weight the person is holding by measuring the characteristics of the person such as the change in tendon sizes using optical and/or ultrasonic sensor technology which can measure the changes in diameter of a muscle or tendon which would then be processed by the wearable device to indicate a strain which would be calculated to indicate the amount of weight the person is holding. The same type of teaching method could be used as described above where the wearable device would be able to be taught as to how much strain is being put on a tendon or muscle when the person is holding a weight value so when a person picks up a weight value the wearable device would have the ability to measure the strain (or diameter or measurement changes in tendons or other internal body elements or external such as skin), compare this data to pre-stored already taught data residing in the wearable device, and then select which weight value was being used by the person and then identify and record that value inside of that workout exercise session.

The wearable device sensors can also be used by the wearable device to detect when a person is starting to struggle with exercising. The sensors will track movement when a person is lifting a free weight device (or working out on a strength machine like a plate loaded weight stack machine). When the person is not struggling, the wearable device will be recording movement data with a repeatable cadence associated with the sensor data (cadence can also be defined as repeatable accelerations or a slope of data being analyzed). When the cadence of the movement data starts to deviate from a threshold value that is associated with the normal, non-struggling movement of the person exercising, the wearable device can provide messaging and other visual and audio indicators to the person while they are exercising and after they are exercising.

For example, if a person where to pick up a dumbbell that was too heavy, the acceleration values would be below a threshold value that the wearable device has stored to indicate a good and safe range of movement for the user. If the person was burning their muscles to exhaustion using a dumbbell where they could perform multiple repetitions, the last of the repetitions may result in recorded movement data which shows shaking patterns that are detected by the wearable device. The shaking patterns are the result of the user getting tired towards the later part of their repetitions. The wearable device would be able to identify these patterns and generate real time messaging and indicators (visual and audio) to the user based on these detected patterns during the exercise and also after the exercise is completed. The wearable device software would be able to analyze the collected movement data and make recommendations to the user such as how much weight they should lift based on a specific exercise type or how many sets and repetitions they should perform (and what their pace should be during the exercise, number of seconds up and down on movement).

It should be appreciated that present invention may be automatically controlled via a processing device as desired. Thus, it is contemplated that the processing device may monitor the system and make automatic adjustments as required. In accordance with the present invention, the method may be implemented, wholly or partially, by a controller operating in response to a machine-readable computer program. In order to perform the prescribed functions and desired processing, as well as the computations therefore (e.g. execution control algorithm(s), the control processes prescribed herein, and the like), the controller may include, but not be limited to, power drivers, current monitoring, temperature sensing/reading articles, a processor(s), computer(s), memory, storage, register(s), timing, interrupt(s), communication interface(s), and input/output signal interface(s), as well as combination comprising at least one of the foregoing. Additionally, the controller (software, firmware and/or any other means of control may monitor proper operation of the system. In case a fault is detected it may switch to a redundant system/component (failure could be due to lightning strike or any other problem).

Moreover, the method may be embodied in the form of a computer or controller implemented processes. The method may also be embodied in the form of computer program code containing instructions embodied in tangible media, such as floppy diskettes, CD-ROMs, hard drives, Solid State Drives (SSD) and/or any other computer-readable medium, wherein when the computer program code is loaded into and executed by a computer or controller, the computer or controller becomes an apparatus for practicing the invention. The invention can also be embodied in the form of computer program code, for example, whether stored in a storage medium, loaded into and/or executed by a computer or controller, or transmitted over some transmission medium, such as over electrical wiring or cabling, through fiber optics, or via electromagnetic radiation, wherein when the computer program code is loaded into and executed by a computer or a controller, the computer or controller becomes an apparatus for practicing the invention. When implemented on a general-purpose microprocessor the computer program code segments may configure the microprocessor to create specific logic circuits.

While the invention has been described with reference to an exemplary embodiment, it should be understood by those skilled in the art that various changes may be made and equivalents may be substituted for elements thereof without departing from the scope of the invention. Moreover, the embodiments or parts of the embodiments may be combined in whole or in part without departing from the scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A Wearable Electronic Device (WED), comprising:
a WED processing device;
a WED memory associated with the WED processing device, wherein the memory stores at least one pre-loaded exercise routine;
a motion sensor, wherein the motion sensor is in signal communication with the WED processing device, and wherein the motion sensor is configured to sense the movement of the WED and generate motion sensor data: and,
communication circuitry, wherein the communication circuitry is in signal communication with the WED processing device and configured to wirelessly communicate with at least one of an exercise device and a RFID tag associated with an exercise device being used by the user of the WED, and
wherein the processing device is configured to,
receive the motion sensor data from the motion sensor,
receive exercise device data from at least of the exercise device and the RFID tag associated with the exercise device;
generate an exercise workout session file by combining the motion sensor data and the exercise device data;
analyze at least one of the motion sensor data and the exercise device data to determine if a pre-loaded exercise routine is being followed;
generate a resultant output for the WED responsive to at least one of the analyzed motion sensor data and the analyzed exercise device data.

2. The wearable electronic device of claim 1, wherein the wearable electronic display device is at least one of a smartwatch device, an accelerometer device, a head mounted frame device, a mobile device, a smartphone and an eyeglass device.

3. The wearable electronic device of claim 1, wherein the motion sensor is a accelerometer based sensor.

4. The wearable electronic device of claim 1, wherein the exercise device is at least one of a free weight device, dumbbell device, weight bench, and strength exercise machine.

5. The wearable electronic device of claim 1, wherein the pre-loaded exercise routine is created by a personal trainer and is downloaded by the user of the WED.

6. The wearable electronic device of claim 1, wherein the generated resultant output associated with the motion sensor data is based on determining if a detected amount of shaking exceeds a shaking threshold value that is stored in the memory of the WED.

7. The wearable electronic device of claim 1, wherein the generated resultant output associated with the exercise device data is based on determining if the correct exercise device is being used.

8. The wearable electronic device of claim 1, wherein the exercise device data is the weight value associated with the exercise device.

9. The wearable electronic device of claim 1, wherein the motion sensor data is associated with at least one of the number of repetitions performed by the user of the WED and the number of sets performed by the user of the WED.
